(19) United States
(12) Patent Application Publication
(10) Pub. No.: US 2007/0265079 A1
(43) Pub. Date: Nov. 15, 2007

(54) TCS brake control system

(76) Inventor: Alvin Yu, Yong He City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/430,002

(22) Filed: May 9, 2006

(51) Int. Cl. A63F 13/00

(52) U.S. Cl. 463/37

(57) ABSTRACT

A TCS brake control system is disclosed. The TCS brake control system of the present invention comprises a steering wheel, a base unit, a track calculation unit, a brake control unit and a connector. The steering wheel is disposed onto the base unit and a circuit is disposed in the base unit. The connector connects the TCS brake control system with a video game machine. The track calculation unit is disposed inside the steering wheel, and the brake control unit is disposed inside the base unit. The track calculation unit is able to evaluate the turning angles of steering wheel according to predetermined numerical values and feed the angle data to the brake control unit. After the brake control unit receives the angles data, the brake control unit can convert them to a series of braking signals so as to mimic the actual braking actions.

### BACKGROUND OF THE INVENTION

1. Field of the Invention

The invention generally relates to a TCS (track control system) brake control system used for video/computer games. More particularly, the invention relates to a TCS brake control system in which braking actions may be done automatically according to the turning angles of the steering wheel and there is no need for the brake pedal unit of the prior art so as to make video/computer games more interesting.

2. Description of the Prior Art

There are various types of video/computer games, and each type of video/computer game has its own features. Both software and hardware are usually needed so that we can enjoy a certain type of video/computer game. In a car racing video game, the use of a regular input device (such as a keyboard or a mouse) would be quite inappropriate. With the fast development in the relevant industries, people would expect a video game that can mimic the actual actions. Hence, in a car racing video game, a steering wheel would be a preferred choice.

Preferably, such steering wheel has an ergonomic design; otherwise, such steering wheel may cause fatigue to a user. An ergonomically designed steering wheel allows a user to use it comfortably and easily. Hence, the relevant video game companies have been making improvements in input/control devices so as to mimic the actual actions.

Though people want video games that can simulate the actual actions, with regard to car racing video games, too many input/control devices (such as steering wheel, gear stick and brake pedal) can make such games less interesting. In addition, in the real world, automobiles have become easier to operate and safety level (such as the use of ABS) of automobiles has been enhanced.

In fact, ABS can prevent the locking of the wheels and can provide superior braking performance in high speed motion and cornering if properly used. Hence, if such brake control mode is incorporated into a car racing video game, such game may become more interesting and a player may get more enjoyment out of such game.

To eliminate the disadvantages of the brake control system of the prior art, the inventor has put in a lot of effort in the subject and has successfully come up with the TCS brake control system of the present invention.

### SUMMARY OF THE INVENTION

The object of the present invention is to provide a TCS brake control system in which braking actions may be done automatically according to the turning angles of the steering wheel and there is no need for the brake pedal unit of the prior art so that it would be easier for a user to concentrate on the video/computer game.

The TCS brake control system of the present invention comprises a steering wheel, a base unit, a track calculation unit, a brake control unit and a connector. The steering wheel is disposed onto the base unit and a circuit is disposed in the base unit. The connector connects the TCS brake control system with a video game machine. The track calculation unit is disposed inside the steering wheel, and the brake control unit is disposed inside the base unit. The track calculation unit is able to evaluate the turning angles of steering wheel according to predetermined numerical values and feed the angle data to the brake control unit. After the brake control unit receives the angles data, the brake control unit can convert them into a series of braking signals so as to mimic the actual braking actions. In use, when we turn the steering wheel, the speed of a vehicle may be automatically controlled through the track calculation unit and the brake control unit, and we do not have to worry about the vehicle may be off the road. Hence, with the brake control system of the present invention, it would be easier for us to concentrate on the game.

### BRIEF DESCRIPTION OF THE DRAWINGS

The drawings disclose an illustrative embodiment of the present invention which serves to exemplify the various advantages and objects hereof, and are as follows:

FIG. 1 is a view schematically illustrating the brake control system of the prior art.

FIG. 2 is a view schematically illustrating the brake control system of the present invention.

List of reference numerals

| | | | |
|---|---|---|---|
| 11 | Steering wheel | 12 | Brake pedal unit |
| 13 | Connector | 21 | Steering wheel |
| 22 | Base unit | 23 | Connector |
| 31 | Track calculation unit | 32 | Brake control unit |

### DETAILED DESCRIPTION OF THE PREFERRED EMBODIMENT

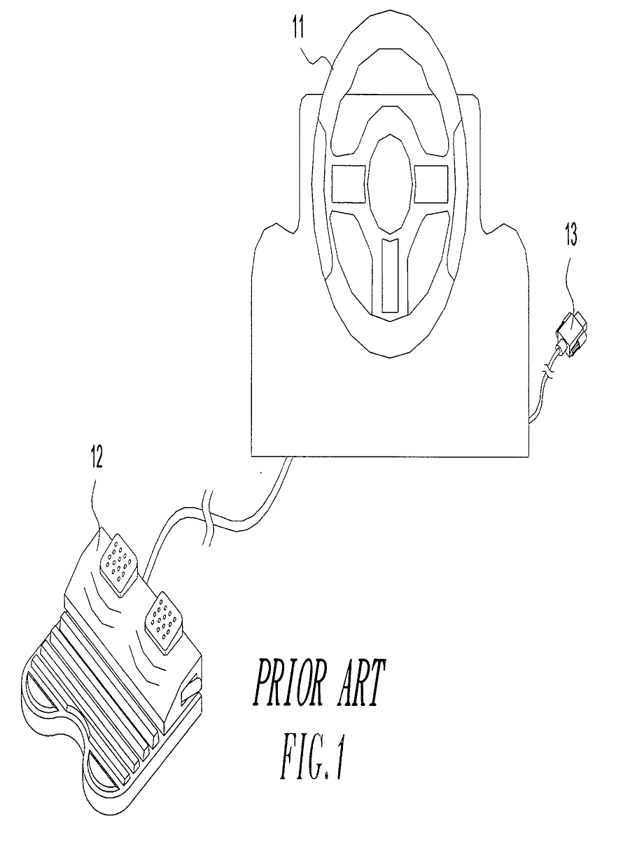

As illustrated in FIG. 1, the brake control system of the prior art comprises a steering wheel 11 and a brake pedal unit 12. The steering wheel 11 may be used to steer, and the brake pedal unit 12 may be used to slow down or stop the corresponding vehicle. A connector 13 is used to connect the brake control system with a video game machine.

The brake control system of the prior art has several disadvantages. First, the steering wheel 11 has only one function and can not provide any additional function. Also, when a user needs to slow down or stop the vehicle, he has to step on the pedals of the brake pedal unit 12, and this causes inconvenience; the use of the brake pedal unit 12 requires more space. In addition, the use of the brake pedal unit 12 requires a higher cost in manufacturing.

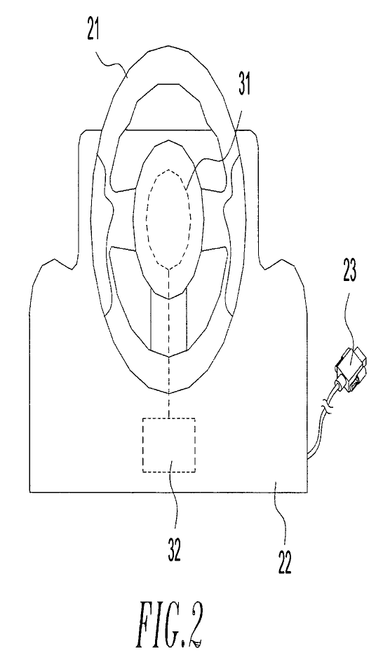

FIG. 2 illustrates the TCS brake control system of the present invention. The TCS brake control system of the present invention comprises a steering wheel 21, a base unit 22, a track calculation unit 31, a brake control unit 32 and a connector 23. The steering wheel 21 is disposed onto the base unit 22 and may be turned around. A circuit is provided inside the base unit 22. The connector 23 is used to connect the TCS brake control system with a video game machine. The track calculation unit 31 is disposed inside the steering wheel 21, and the brake control unit 32 is disposed inside the base unit 22. The track calculation unit 31 is able to evaluate the turning angles of steering wheel 21 according to predetermined numerical values and feed the angle data to the brake control unit 32. After the brake control unit 32 receives the angles data, the unit 32 can convert them into a series of braking signals.

In an actual condition, when a vehicle is cornering at a high speed, the driver has to turn the steering wheel by a large angle and step on the brake pedal in the mean time; in such case, the force that the driver exerts on the brake pedal and the period of braking are dependant on his experience. When the TCS brake control system of the present invention is used, the brake control unit 32 can send out more braking signals (for example, 100 to 200 times of braking if the steering wheel is turned by an angle from 35 degree to 90 degree; also, the times of braking may be adjusted so as to meet the actual needs).

The track calculation unit 31 may be of mechanical structure or electronic structure; a chip, an electronic circuit or a software program may be used to covert the turning angles of steering wheel 21 into appropriate numerical values. While, the brake control unit 32 may be consisted of hardware or a software program so as to determine the interval between braking actions and the period of braking. In addition, both of the track calculation unit 31 and the brake control unit 32 are programmable, and the numerical values so programmed or set may be stored in the base unit 22. If the software of a game supports such application, such application may be used.

The connector 23 may be an ordinary connector in the forms of USB, IEEE1394, RS232 and other forms available in the future. Also, the connector 23 may be of wireless connection in the forms of WI-FI, Bluetooth, RF, infrared and other forms available in the future.

In use, when we turn the steering wheel 21, the speed of a vehicle may be automatically controlled through the track calculation unit 31 and the brake control unit 32 and we do not have to worry about the vehicle may be off the road. Hence, with the TCS brake control system of the present invention, it would be easier for us to concentrate on the game.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A TCS brake control system, comprising:
a steering wheel;
a base unit, onto which the steering wheel is disposed and having a circuit;
a track calculation unit, disposed inside the steering wheel and able to evaluate the turning angles of steering wheel;
a brake control, disposed inside the base unit and able to convert the angle data fed from the track calculation unit into a series of braking signals unit; and
a connector, connecting the TCS brake control system with a video game machine.

2. The TCS brake control system as in claim 1, wherein both of the track calculation unit and the brake control unit are programmable through the manner of hardware or software.

3. The TCS brake control system as in claim 1, wherein the track calculation unit may be of mechanical structure or electronic structure, and a chip, an electronic circuit or a software program may be used to covert the turning angles of steering wheel into numerical values.

4. The TCS brake control system as in claim 1, wherein the brake control unit may be consisted of hardware or a software program so as to determine the interval between braking actions and the period of braking.

5. The TCS brake control system as in claim 1, wherein the connector may be an ordinary connector in the forms of USB, IEEE1394, RS232 or other forms available in the future.

6. The TCS brake control system as in claim 1, wherein the connector may be of wireless connection in the forms of WI-FI, Bluetooth, RF, infrared and other forms available in the future.
